(19) United States
(12) Patent Application Publication
(10) Pub. No.: US 2024/0273339 A1
(43) Pub. Date: Aug. 15, 2024

(54) MIXTURE-OF-EXPERT BASED NEURAL NETWORKS

(71) Applicant: PAYPAL, INC., San Jose, CA (US)

(72) Inventors: Wei Zhao, Shanghai (CN); Zexia Zhou, Shangahi (CN); Jiahui Qian, Shanghai (CN); Sizhe Wan, Shangahai (CN)

(21) Appl. No.: 18/169,699

(22) Filed: Feb. 15, 2023

(51) Int. Cl. G06N 3/042; G06N 3/08

(52) U.S. Cl. CPC G06N 3/042; G06N 3/08

(57) ABSTRACT

Methods and systems are presented for configuring, training, and utilizing a machine learning model that includes different experts corresponding to different domains, such that the machine learning model may facilitate transfer of knowledge acquired from one domain to another domain and to use different mixtures of experts to perform tasks across the different domains. The machine learning model includes individual domain experts configured to process input values corresponding to features that are unique to the corresponding domains. The machine learning model also includes a common expert configured to process input values corresponding to features that are common to the different domains. By training the machine learning model using training data associated with a first domain, both a first domain expert and the common expert are trained. The knowledge acquired by the common expert can then be utilized when processing tasks associated with a second domain.

### BACKGROUND

The present specification generally relates to machine learning models, and more specifically, to transfer learning techniques for machine learning models according to various embodiments of the disclosure.

### RELATED ART

Machine learning models have been widely used to perform various tasks for different reasons. For example, machine learning models may be used in classifying data (e.g., determining whether a transaction is a legitimate transaction or a fraudulent transaction, determining whether a merchant is a high-value merchant or not, determining whether a user is a high-risk user or not, etc.). To construct a machine learning model, a set of input features that are related to performing a task associated with the machine learning model are identified. Training data that is associated with the type of task to be performed by the machine learning model (e.g., historic transactions) can be used to train the machine learning model such that the machine learning model can learn various patterns associated with the training data and perform classification predictions based on the learned patterns.

While machine learning models can be effective in learning patterns and making predictions, a conventional machine learning model is typically inflexible regarding the task that the machine learning model is configured to perform and the input features used to perform the tasks once they are configured and trained. For example, once a machine learning model is configured and trained to perform a first task (e.g., a classification of transactions of a first type, etc.) based on a first set of input features, it is often difficult (and computer resources intensive) to configure the same machine learning model to perform a different task (e.g., a second task), due to the fact that the second task may require a different set of input features (e.g., a second set of input features) and/or that the second task may be associated with different patterns than those learned by the machine learning model in association with the first task.

It has been contemplated that as machine learning models are being asked to perform more and more predictions or tasks, the tasks will become more diverse as well. As such, there is a need for providing a framework for generating machine learning models that are flexible to perform tasks across different domains effectively.

### BRIEF DESCRIPTION OF THE FIGURES

FIG. 1 is a block diagram illustrating an electronic transaction system according to an embodiment of the present disclosure;

FIG. 2 illustrates the use of different machine learning models to perform tasks associated with different domains according to an embodiment of the present disclosure;

FIG. 3 illustrates an example machine learning model that uses mixtures of different experts to perform tasks across different domains according to an embodiment of the present disclosure;

FIG. 4 illustrates a transaction processing module that uses mixture of expert based machine learning models to perform tasks across different domains according to an embodiment of the present disclosure;

FIG. 5 is a flowchart showing a process of generating and training a machine learning model that includes multiple experts for performing tasks across multiple domains according to an embodiment of the present disclosure;

FIG. 6 is a flowchart showing a process of utilizing a machine learning model that uses a mixture of experts to perform tasks associated with different domains according to an embodiment of the present disclosure;

FIG. 7 illustrates an example neural network that can be used to implement a machine learning model according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for configuring, training, and utilizing a machine learning model that includes multiple experts corresponding to multiple domains, such that the machine learning model can be configured and trained to use different mixtures (e.g., different combinations) of experts to perform tasks across multiple domains effectively (e.g., having a prediction accuracy at or above a threshold). As discussed herein, conventional machine learning models can be inflexible, in that they are generally limited to performing a specific task in a particular domain effectively (e.g., having a prediction accuracy at or above the threshold), but cannot handle tasks in multiple domains.

It has been contemplated that as an organization expands or as more types of transactions are being conducted, the types of tasks required to be performed by the organization may become more diverse. Using an example of an organization that provides payment processing services, the organization may have been providing services related to a first type of payment transaction (e.g., transactions conducted through the Automated Clearing House (ACH), etc.) to its users. As such, the organization may have developed and trained a first machine learning model to perform a first task (e.g., predicting whether a transaction is a fraudulent transaction) associated with a first domain (e.g., ACH transactions). The first machine learning model may be configured to receive input data that is associated with an ACH transaction and corresponding to a first set of features related to the first domain, and provide an output that indicates whether the ACH transaction is a fraudulent transaction. After the organization has been providing such a service for a period of time, the organization may use historic transaction data (e.g., transactions of the first type, such as ACH transactions, that have been conducted by the organization in the past) to train the first machine learning model such that the first machine learning model may perform the first task associated with the first domain more effectively (e.g., having a prediction accuracy at or above the threshold).

Consider a scenario when the organization expands its services by providing payment processing for a second type of payment transaction (e.g., debit card transactions, cryptocurrency transactions, etc.). In order to process transactions of the second type, the organization may be required to perform a second task associated with a second domain (e.g., predicting whether a transaction of the second type is a fraudulent transaction). Since the second type of payment transaction may be different from the first type of payment transaction in a certain way, the first machine learning model that was configured and trained to perform the first task associated with the first domain may not be fully compatible or effective with performing the second task associated with the second domain. For example, the second domain may be associated with a second set of features that does not fully overlap with the first set of features associated with the first domain. As such, if the first machine learning model were to perform the second task, the first machine learning model may not be able to consider all of the relevant information (e.g., features that are unique to the second domain) associated with transactions in the second domain when performing the task. Furthermore, the transaction patterns learned by the first machine learning model based on the historical transactions associated with the first domain may not be completely relevant to the second domain, such that the first machine learning model may not perform the second task with a satisfactory accuracy.

Alternatively, the organization may develop a second machine learning model that is configured to perform the second task associated with the second domain (e.g., predicting whether a debit card transaction is a fraudulent transaction). The second machine learning model may be configured to receive input values corresponding to the second set of features related to the second domain, such that the second machine learning model, when performing the second task, is able to fully analyze relevant information of a transaction in association with the second domain. However, since the organization lacks reliable training data related to the second domain (e.g., as the organization has not had a long history of performing debit card transactions) to train the second machine learning model, the second machine learning model may also not be able to perform the second task with a satisfactory accuracy.

Since the first domain (e.g., ACH transactions) and the second domain (e.g., debit card transactions) may share one or more common characteristics, certain knowledge (e.g., patterns) learned by the first machine learning model from the training data associated with the first domain may be applicable for the second domain. It would be desirable for the organization to transfer such knowledge that is relevant to the second domain for performing the second task, such that the second task can be performed with a satisfactory accuracy before reliable training data associated with the second domain is obtained.

Accordingly, in some embodiments of the disclosure, a transaction processing system of the organization may generate a machine learning model for facilitating transfer of knowledge across multiple domains, and utilize such a machine learning model for performing tasks associated with the multiple domains. In some embodiments, the machine learning model generated by the transaction processing system may include multiple experts associated with the different domains. The multiple experts may include a first domain expert that is configured to analyze data and acquire knowledge unique to the first domain, a second domain expert that is configured to analyze data and acquire knowledge unique to the second domain, and a common expert that is configured to analyze data and acquire knowledge that is common to (e.g., shared by) the first domain and the second domain. Based on the different experts, and specifically, different mixtures (e.g., combinations) of the experts, the machine learning model may be configured and trained to perform tasks associated with different domains based on a limited amount of training data (e.g., training data associated with only a subset, but not all, of the domains).

For example, the machine learning model may utilize the first domain expert and the common expert to perform tasks associated with the first domain. The machine learning model may also utilize the second domain expert and the common expert to perform tasks associated with the second domain. In some embodiments, training data associated with either domain (e.g., the first domain or the second domain) or training data associated with both domains may be used to train the machine learning model. When only training data associated with the first domain is used to train the machine learning model, the first domain expert and the common expert of the machine learning model are trained—that is, the internal structures and/or the parameters of the first domain expert and the common expert are modified based on the training data according to a loss function. Since the common expert is trained along with the first domain expert based on the training data associated with the first domain, the knowledge acquired by the common expert from the training data and that is relevant to the second domain may be used when performing the second task associated with the second domain. Similarly, when only training data associated with the second domain is used to train the machine learning model, the knowledge acquired by the common expert form the training data and that is relevant to the first domain may be used when performing the first task associated with the first domain. When training data associated with both of the first domain and the second domain is used to train the machine learning model, the first domain expert and the second domain expert may be trained based on patterns learned from the respective training data, while the common expert may be trained based on patterns learned from all of the training data. Thus, the common expert is benefited from knowledge acquired for both domains. The knowledge acquired by the common expert can be applied when the machine learning model perform tasks associated with either the first domain or the second domain. As a result, knowledge acquired from one domain can be transferred and used in a task associated with a different domain using the machine learning model as disclosed herein, resulting in improved prediction performance by the machine learning model.

In some embodiments, the machine learning model generated by the transaction processing system may be implemented using an artificial neural network structure. As such, the machine learning model may include one or more input layers, one or more hidden layers, and one or more output layers. When the machine learning model is implemented using an artificial neural network structure, the first domain expert may include a first input layer configured to receive input data that is unique to the first domain. The input data received by the first input layer may correspond to a first subset of features, from the first set of features, that is unique to the first domain. That is, the first subset of features does not include any feature that is shared with the second set of features associated with the second domain. The first domain expert may also include a first set of hidden layers that is connected to the first input layer. In some embodiments, the first set of hidden layers may be configured to receive the input values from the first input layer, manipulate the input values based on parameters associated with the nodes in the first set of hidden layers, and provide one or more intermediate output values.

In some embodiments, the second domain expert may include a second input layer configured to receive input data unique to the second domain. The input data received by the second input layer may correspond to a second subset of features, from the second set of features, that is unique to the second domain. That is, the second subset of features does not include any feature that is shared with the first set of features associated with the first domain. The second domain expert of the machine learning model may also include a second set of hidden layers that is connected to the second input layer. In some embodiments, the second set of hidden layers may be configured to receive the input values from the second input layer, manipulate the input values based on parameters associated with the nodes in the second set of hidden layers, and provide one or more intermediate output values.

In some embodiments, the common expert of the machine learning model may also include a third input layer configured to receive input data that is common (e.g., shared) between the first and second domains. The input data received by the third input layer may correspond to a set of common features that is shared between the first and second domains. That is, all of the features in the set of common features are included in both the first set of features associated with the first domain and the second set of features associated with the second domain. The common expert of the machine learning model may also include a third set of hidden layers that is connected to the third input layer. In some embodiments, the third set of hidden layers may be configured to receive the input values from the third input layer, manipulate the input values based on parameters associated with the nodes in the third set of hidden layers, and provide one or more intermediate output values.

In some embodiments, the first domain expert, the second domain expert, and the common expert are not connected to each another, such that each expert can be trained and utilized independent of each other. However, when performing tasks associated with a particular domain, a mixture (e.g., a combination) of at least some of the experts is utilized by the machine learning model to analyze the data and provide an output. Thus, in some embodiments, the machine learning model may also include one or more aggregators that combine at least some of the experts in the machine learning model. In the example where the machine learning model is configured to perform tasks associated with the first domain and the second domain, the machine learning model may include a first domain aggregator that connects the first domain expert and the common expert, and a second domain aggregator that connects the second domain expert and the common expert. Each of the aggregators may include one or more hidden layers, and may be configured to receive one or more intermediate outputs from the connected experts, manipulate the intermediate outputs based on the parameters associated with the nodes in the one or more hidden layers, and provide one or more outputs to a corresponding output layer of the machine learning model.

For example, the machine learning model may include a first domain aggregator that connects the first domain expert and the common expert. The first domain aggregator may be configured to obtain one or more intermediate outputs from the first domain expert and one or more intermediate outputs from the common expert. The first domain aggregator may then manipulate the intermediate outputs from the two domains (such that the data associated with the two domains can be analyzed collectively), and provide one or more outputs to a first domain output layer of the machine learning model. The machine learning model may also include a second domain aggregator that connects the second domain expert and the common expert. The second domain aggregator may be configured to obtain one or more intermediate outputs from the second domain expert and one or more intermediate outputs from the common expert. The second domain aggregator may then manipulate the intermediate outputs from the two domains, and provide one or more outputs to a second domain output layer of the machine learning model. This way, data relevant to each domain may be aggregated and analyzed as a whole (e.g., collectively) by the corresponding domain aggregators before providing an output for the corresponding task.

Thus, when the machine learning model performs the first task associated with the first domain, the machine learning model may receive input values corresponding to the first set of features via the first input layer of the first domain expert and the third input layer of the common expert. The first domain expert and the common expert may analyze and manipulate the input data independent of each other, and may provide respective intermediate output values to the first domain aggregator. The first domain aggregator may obtain the respective intermediate output values from the first domain expert and the common expert, analyze and manipulate the intermediate output values as a whole (e.g., collectively), and may provide one or more output to the first output layer as an output for the first task.

Similarly, when the machine learning model performs the second task associated with the second domain, the machine learning model may receive input values corresponding to the second set of features via the second input layer of the second domain expert and the third input layer of the common expert. The second domain expert and the common expert may analyze and manipulate the input data independently, and may provide respective intermediate output values. The second aggregator may obtain the respective intermediate output values from the second domain expert and the common expert, analyze and manipulate the intermediate output values as a whole (e.g., collectively), and may provide one or more output to the second output layer as an output for the second task.

To further improve the performance of the machine learning models in performing tasks across the different domains, the machine learning model of some embodiments may also include one or more gates between the experts and the aggregators for controlling the contribution factors of the intermediate outputs provided by corresponding experts. For example, the machine learning model may include a first domain gate that controls the contribution factors of (e.g., by assigning weights to) the intermediate outputs provided by the first domain expert and the intermediate outputs provided by the common expert in the first domain aggregator when performing the first task associated with the first domain. The machine learning model may also include a second domain gate that controls the contribution factors of (e.g., by assigning weights to) the intermediate outputs provided by the second domain expert and the intermediate outputs provided by the common expert in the second domain aggregator when performing the second task associated with the second domain. This way, the intermediate outputs generated by the common expert can contribute to the overall task differently when the machine learning model is performing tasks associated with the different domains. In some embodiments, the contribution factors may be determined through the training process of the machine learning model. In some embodiments, the contribution factors may be dynamically determined based on the input values.

The machine learning model implemented using the techniques disclosed herein is also scalable. For example, additional domain(s) (that is related to the first and second domains) can be incorporated into the machine learning model by adding additional domain expert(s), domain aggregator(s), and domain gate(s). Different mixtures (or combinations) of the experts can be used to perform tasks associated with the additional domain(s). For example, if a third domain is incorporated into the machine learning model, a third domain expert and the common expert can be utilized in performing the task associated with the third domain. A third domain aggregator can combine the intermediate outputs from the two domains and perform further analysis and manipulation collectively before providing a prediction output.

When training data associated with other domains become available (e.g., after the organization has conducted a sufficient number of transactions in the second domain), the machine learning model can be re-trained using the newly available training data. Training the machine learning model using training data specifically associated with the second domain would not only improves the prediction performance of the machine learning model for performing the second task associated with the second domain, but also improve the prediction performance of the machine learning model for performing tasks associated with the other domains, as the common expert is further trained and adjusted through the training. In some embodiments, after training the machine learning model using training data specifically associated with the second domain, the various gates (e.g., the first domain gate, the second domain gate, the third domain gate, etc.) may also need to be adjusted based on the adjustment made to the common expert. In some embodiments, when training data associated with multiple domains is available, the transaction processing system may merge the training data associated with the multiple domains (such that the training data associated with the multiple domains are interlaced with each other in a training data set), and the merged training data set can be used to train the machine learning model.

By using the machine learning model that uses a mixture of experts as disclosed herein, the transaction processing system may perform different tasks associated with different domains using a single machine learning model, which can perform tasks associated with a domain having a satisfactory (e.g., at or above a prediction accuracy threshold for the task) accuracy performance even when insufficient training data associated with that domain is available to the transaction processing system. Using a single machine learning model to perform tasks across multiple domains has many benefits, such as providing a more efficient way to store and maintain the machine learning model, reducing resources in configuring, training, and maintaining the machine learning model, easier to distribute the machine learning model across different edge servers, etc.

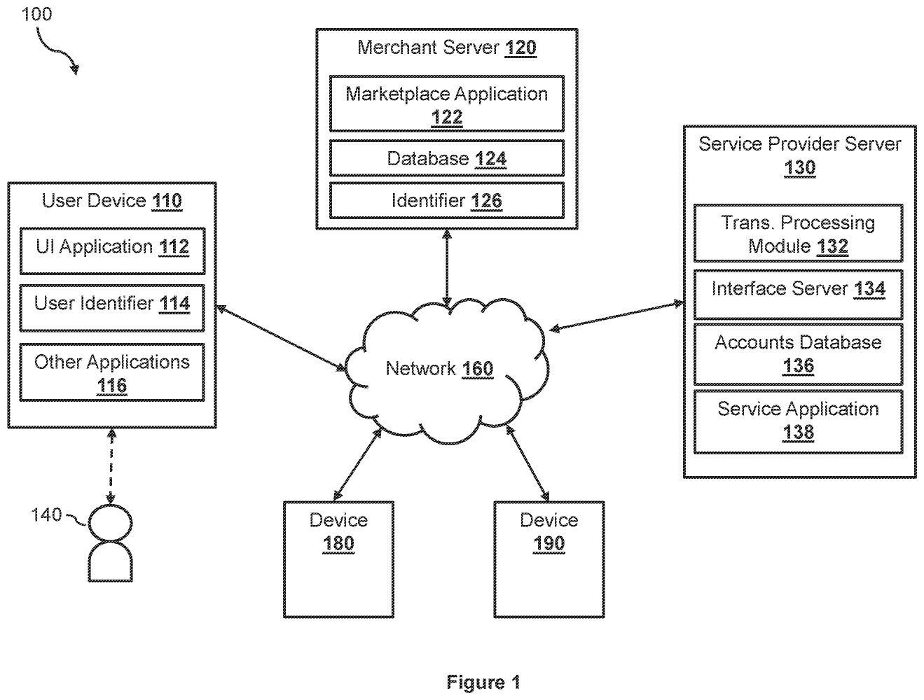

FIG. 1 illustrates an electronic transaction system 100, within which the transaction processing system may be implemented according to one embodiment of the disclosure. The electronic transaction system 100 includes a service provider server 130, a merchant server 120, a user device 110, and devices 180 and 190 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding account, to perform an electronic purchase with a merchant associated with the merchant server 120, to provide information associated with the new funding account, to initiate an electronic payment transaction with the service provider server 130, to apply for a financial product through the service provider server 130, to access data associated with the service provider server 130, etc.).

In some embodiments, each of the devices 180 and 190 may include similar components as the user device 110, and may enable its user to communicate with and conduct transactions with the merchant server 120 and/or the service provider server 130 in the same manner as discussed herein.

The merchant server 120, in various embodiments, may be maintained by a business entity (or in some cases, by a partner of a business entity that processes transactions on behalf of business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user device 110 and devices 180 and 190 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing of electronic transactions between the users of the user device 110 and/or the devices 180 and 190, and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal©, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements the transaction processing system as discussed herein. The transaction processing module 132 may be configured to process transaction requests received from the user device 110 and/or the merchant server 120 via the interface server 134. In some embodiments, based on the products and/or services offered by the service provider associated with the service provider server 130, the transaction processing module 132 may be required to process transactions across multiple domains. For example, the service provider may initially enable its users to conduct electronic payment transactions through Automated Clearing House (ACH). The service provider may then to offer additional products and/or services to its users, such as enabling the users to conduct electronic payment transactions using debit cards, conduct cryptocurrency transactions (e.g., purchasing and/or selling coins in a cryptocurrency), or other types of payment transactions. As such, the transaction processing module 132 may be required to perform tasks across multiple domains (e.g., predicting a risk of an ACH transaction, predicting a risk of a debit card transaction, predicting a risk of a cryptocurrency transaction, etc.).

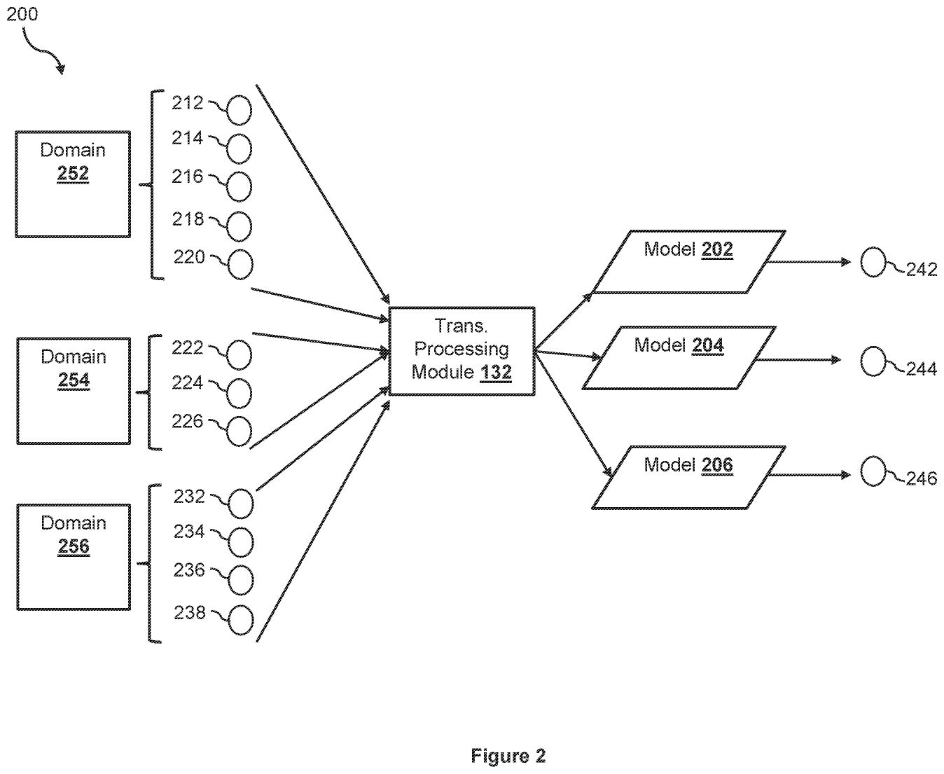

FIG. 2 illustrates an example computer infrastructure 200 that enables the transaction processing module 132 to perform tasks across multiple domains. In this example computer infrastructure 200, the transaction processing module 132 may use multiple machine learning models 202, 204, and 206 to perform the tasks associated with the different domains 252, 254, and 256, respectively. In some embodiments, during the time when the service provider has been processing ACH transactions, the transaction processing module 132 may have developed and trained the machine learning model 202 for performing tasks associated with the domain 252 (e.g., predicting risks of ACH transactions). The machine learning model 202 may be configured to receive input values corresponding to a set of features, that includes features 212, 214, 216, 218, and 220, related to the domain 252, and provide an output 242 that indicates a risk of an ACH transaction. Since the service provider has been processing ACH transactions for a period of time, the transaction processing module 132 may use historic transaction data (e.g., past ACH transactions conducted by the transaction processing module 132) to train the machine learning model 202. With sufficient training data available to the transaction processing module 132, the machine learning model 202 can be trained (e.g., learning patterns associated with predicting risks in ACH transactions) to perform the first task associated with the first domain with a satisfactory accuracy performance (e.g., having an accuracy level at or above a threshold).

When the service provider begins to offer other services, such as processing debit card transactions and cryptocurrency transactions, the transaction module 132 may use the same machine learning model 202 to perform the tasks associated with the other domains 254 and 256 (e.g., predicting risks in debit card transactions and cryptocurrency transactions, etc.). However, since the features related to the other domains may not completely overlap with the set of features related to the domain 252 (e.g., ACH transactions), and the patterns for the other domains 254 and 256 may not be the same as the patterns derived from the domain 252, the machine learning model 202 may not perform tasks associated with these other domains 254 and 256 with a satisfactory accuracy. In this example as shown in FIG. 2, the domain 254 may be related to a set of features that includes features 222, 224, and 226, and the domain 256 may be related to a set of features that includes features 232, 234, 236, and 238, that may not be completely overlapping with the set of features related to the domain 252.

Alternatively, the transaction processing module 132 may develop other machine learning models 204 and 206 for performing tasks associated with the domains 254 and 256, respectively. For example, the transaction processing module 132 may configure the machine learning model 204 to accept input values corresponding to the features 222, 224, and 226, and may configure the machine learning model 206 to accept input values corresponding to the features 232, 234, 236, and 238, such that the machine learning models 204 and 206 may consider input data that is relevant to the respective domains when performing the tasks associated with the respective domains. However, since the service provider may have just begun offering these products and/or services to its users, there may not be sufficient historic transaction data associated with the domains 254 and 256 that can be used as training data to effectively train the machine learning models 204 and 206. Thus, at least initially before the transaction processing module 132 has access to sufficient reliable training data associated with the domains 254 and 256, the machine learning models 204 and 206 may not perform with a satisfactory accuracy as well.

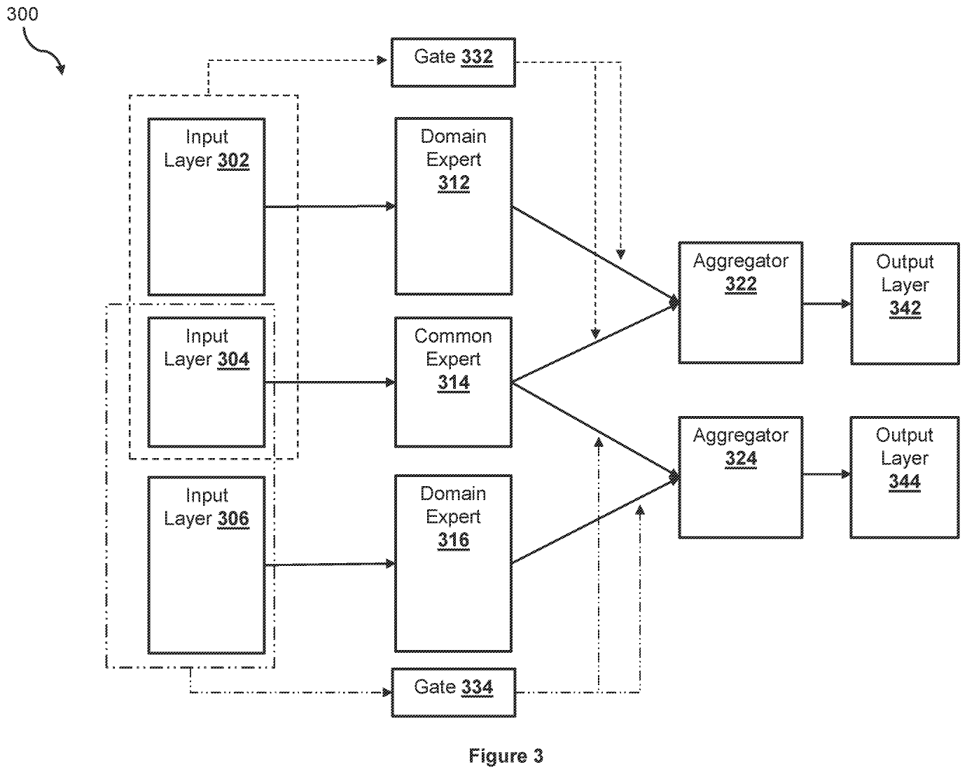

As such, the transaction processing module 132 may implement a machine learning model as disclosed herein, that uses a mixture of experts that enables the machine learning model to transfer knowledge across multiple domains and perform tasks across multiple domains. FIG. 3 illustrates an example machine learning model 300 that uses a mixture of experts to perform tasks across multiple domains as disclosed herein. As discussed herein, different domains may be related to different features. Features that are related to a domain specify the types of data that are relevant to the machine learning model 300 in performing tasks associated with the domain. When the task for the domain is associated with predicting a risk of an ACH transaction, the features may include a monetary amount in the ACH transaction, device characteristics associated with the user device used to initiate the ACH transaction, bank characteristics associated with the banks involved in the ACH transaction, a user profile of the user conducting the ACH transaction, and others. When the task for the domain is associated with predicting a risk of a debit card transaction, the features may include a monetary amount in the debit card transaction, device characteristics associated with the user device used to initiate the debit card transaction, merchant characteristics of a merchant involved in the debit card transaction, a user profile of the user conducting the ACH transaction, and others. When the task for the domain is associated with predicting a risk of a cryptocurrency transaction, the features may include a monetary amount in the cryptocurrency transaction, device characteristics associated with the user device used to initiate the cryptocurrency transaction, characteristics of a cryptocurrency broker involved in the cryptocurrency transaction, a user profile of the user conducting the ACH transaction, and others. As such, while the features related to the different domains are different, they can partially overlap because of the similarities among the different domains.

In some embodiments, the transaction processing module 132 may configure the machine learning model 300 based on the features that are unique to each of the domains and features that are common to the different domains. In an example where the machine learning model is being developed to perform tasks across two different domains 252 and 254, the transaction processing module 132 may determine, from the set of features associated with the domain 252, a first subset of features that is unique to the domain 252. That is, none of the features in the first subset of features is shared with other domains (e.g., the domain 254, the domain 256, etc.). The transaction processing module 132 may also determine, from the set of features associated with the domain 254, a second subset of features that is unique to the domain 254. That is, none of the features in the second subset of features is shared with other domains (e.g., the domain 252, the domain 256, etc.). The transaction processing module 132 may then identify the remaining features that are common to both the domains 252 and 254.

After determining the three sets of features (e.g., one set that is unique to the domain 252, another set that is unique to the domain 254, and another set that is common to the features 252 and 254), the transaction processing module 132 may configure the machine learning model 300 according to these three sets of features. For example, the transaction processing module 132 may configure the machine learning model 300 to include a domain expert 312 that handles data that is unique to the domain 252 (e.g., data that corresponds to the first subset of features unique to the domain 252), a domain expert 316 that handles data that is unique to the domain 254 (e.g., data that corresponds to the second subset of features unique to the domain 254), and a common expert 314 that handles data that is common across the domains 252 and 254 (e.g., data that corresponds to the features shared by the domains 252 and 254). For each of the experts 312, 314, and 316, the transaction processing module 132 may provide a respective input layer for receiving the corresponding input data. For example, the transaction processing module 132 may configure the machine learning model 300 to include an input layer 302 for receiving input data corresponding to features that are unique to the domain 252 and to be processed by the domain expert 312, an input layer 306 for receiving input data corresponding to features that are unique to the domain 254 and to be processed by the domain expert 316, and an input layer 304 for receiving input data corresponding to features that are common to the domains 252 and 254, and to be processed by the common expert 314. In some embodiments, the input layers 302, 304, and 306 may be a part of the domain expert 312, the common expert 314, and the domain expert 316, respectively.

Each of the experts 312, 314, and 316 may also include one or more hidden layers of nodes. As an input layer passes the input values to a corresponding expert, the expert may be configured to analyze and manipulate the input values through the one or more hidden layers based on the parameters associated with the nodes in the one or more hidden layers. Each expert may also be configured to provide one or more intermediate output values based on the manipulation of the corresponding input values.

In some embodiments, the transaction processing module 132 may also include one or more aggregators in the machine learning model 300 for aggregating the intermediate output values and analyzing the aggregated intermediate output values collectively. Each aggregator may correspond to a distinct domain, such that the aggregator would aggregate the intermediate output values associated with the corresponding domain. In this example, since the machine learning model 300 is configured to perform tasks associated with two domains 252 and 254, the transaction processing module 132 may include an aggregator 322 corresponding to the domain 252 and an aggregator 324 corresponding to the domain 254. The aggregator 322 is configured to aggregate the intermediate output values generated by the domain expert 312 and the intermediate output values generated by the common expert 314. The aggregator 322 may also include one or more hidden layers, such that the aggregated intermediate output values may be further manipulated collectively (e.g., based on the parameters associated with the nodes in the one or more hidden layers) before the aggregator 322 provides one or more output values to the output layer 342.

Similarly, the aggregator 324 is configured to aggregate the intermediate output values generated by the domain expert 316 and the intermediate output values generated by the common expert 314. The aggregator 324 may also include one or more hidden layers, such that the aggregated intermediate output values may be further manipulated collectively (e.g., based on the parameters associated with the nodes in the one or more hidden layers) before the aggregator 324 provides one or more output values to the output layer 344.

When the machine learning model 300 perform tasks associated with the domain 252 (e.g., predicting a risk associated with an ACH transaction), input values associated with the ACH transaction and corresponding to features related to the domain 252 may be received via the input layers 302 and 304. The input values may be passed on to the domain expert 312 and the common expert 314, respectively. The domain expert 312 may analyze and manipulate the input values from the input layer 302 (independent from the common expert 314) and provide one or more intermediate output values to the aggregator 322. The common expert 314 may analyze and manipulate the input values from the input layer 304 (independent from the domain expert 312) and provide one or more intermediate output values to the aggregator 322. The aggregator 322 aggregates the intermediate output values from the domain expert 312 and the common expert 314, performs further manipulations collectively, and provides one or more output values to the output layer 342, as an output of the machine learning model 300.

When the machine learning model 300 perform tasks associated with the domain 254 (e.g., predicting a risk associated with a debit card transaction), input values associated with the debit card transaction and corresponding to features related to the domain 254 may be received via the input layers 304 and 304. The input values may be passed on to the domain expert 316 and the common expert 314, respectively. The domain expert 316 may analyze and manipulate the input values from the input layer 306 (independent from the common expert 314) and provide one or more intermediate output values to the aggregator 324. The common expert 314 may analyze and manipulate the input values from the input layer 304 (independent from the domain expert 316) and provide one or more intermediate output values to the aggregator 324. The aggregator 324 aggregates the intermediate output values from the domain expert 316 and the common expert 314, performs further manipulations collectively, and provides one or more output values to the output layer 344, as an output of the machine learning model 300.

In some embodiments, gates 332 and 334 may be provided to the machine learning model 300 to control the contribution factors of the intermediate output values from each of the experts 312, 314, and 316. For example, the gate 332 may be configured to intercept the intermediate output values from the domain expert 312 and the common expert 314 when the machine learning model 300 performs a task associated with the domain 252, and to apply weights to the different intermediate output values before the weighted output values are passed on to the aggregator 322. Similarly, the gate 334 may be configured to intercept the intermediate output values from the domain expert 316 and the common expert 314 when the machine learning model 300 performs a task associated with the domain 254, and to apply weights to the different intermediate output values before the weighted output values are passed on to the aggregator 324. Such a control of contribution factors from the different experts provided by the gates 332 and 334 enables finer adjustments and tuning of the machine learning model 300, such that while the common expert 314 is utilized the same way to perform tasks associated with both domains 252 and 254, the intermediate output from the common expert 314 can have different impacts to the final analysis and output of the machine learning model 300 based on the weights assigned to them by the gates 332 and 334. In some embodiments, each of the gates 332 and 334 may dynamically apply different weights to the intermediate outputs, such as based on input values received by the input layers 302, 304, and 306 (e.g., a time of the transaction, an amount associated with the transaction, etc.).

Once the machine learning model 300 is developed, the transaction processing module 132 may train the machine learning model 300 using training data. For example, the transaction processing module 132 may generate training data using historic transaction data associated with transactions in the domain 252. The training data may include attributes of the historic transactions in the domain 252 and labels that characterize the known risks of the transactions. By providing the training data through the machine learning model, the machine learning model 300 may learn knowledge from the training data—that is, the internal structure and parameters associated with the various experts 312, 314, and 316, the aggregators 322, and 324, and the gates 332 and 334 may be manipulated according to the labels and the loss function.

Since each of the experts 312, 314, 316 is configured to analyze and manipulate the corresponding input values independent from other experts, each expert can be trained and/or perform tasks independently without influence from and relying on the other experts. This way, each of the experts can be effectively trained even when the training data does not include data that corresponds to the features associated with all of the input layers 302, 304, and 306. For example, when training data associated with the domain 252 is used to train the machine learning model 300, since the training data includes input values corresponding to features that are unique to the domain 252 and features that are common to both the domains 252 and 254, the training data would pass through the input layers 302 and 304, then to the domain experts 312 and 314, and then to the aggregator 322. Based on one or more loss functions associated with the machine learning model 300, the domain expert 312 and the common expert 314 may learn patterns associated with the training data. That is, one or more parameters associated with the nodes of the domain expert 312 and the common expert 314 may be manipulated according to the loss function based on the training data, even when the domain expert 316 remains unchanged.

After training the machine learning model 300 with the training data associated with the domain 352, the machine learning model 300 may perform tasks associated with either the domain 252 or the domain 254. When the machine learning model 300 performs a task associated with the domain 252, the trained domain expert 312, the trained common expert 314, and the trained aggregator 322 may work together to provide an output. Based on the training provided to the machine learning model 300, the machine learning model can perform the task associated with the domain 252 with a satisfactory prediction accuracy (e.g., having a prediction accuracy at or above a threshold).

The machine learning model 300 may also perform tasks associated with the domain 254. When performing a task associated with the domain 254, input values may be provided to the input layers 304 and 306, and passed on to the common expert 314 and the domain expert 316. Even though the domain expert 316 may not have been trained, the common expert 314 that also participates in the processing of the task associated with the domain 254, has been trained, and has acquired knowledge that may be relevant to the domain 254. As such, the trained common expert 314 may improve the prediction performance for the machine learning model 300 in performing tasks associated with the domain 254 even through the machine learning model has not been trained with any training data (or trained with insufficient training data below a threshold) related to the domain 254.

When the transaction processing module 132 has processed transactions in the domain 254 (e.g., debit card transactions) for a period of time, the transaction processing module 132 may be able to generate additional training data that is specifically related to the domain 254. The transaction processing module 132 may then re-train the machine learning model 300 using the newly generated training data associated with the domain 254. The re-training using the training data related to the domain 254 may cause the domain expert 316, the common expert 314, and the aggregator 324 to be adjusted (e.g., adjusting the parameters associated with the nodes within the experts and/or the aggregator) according to a loss function. Since the re-training using the training data related to the domain 254 would improve the performance of the common expert 314, in addition to the domain expert 316 and the aggregator 324, the retraining not only improves the performance of the machine learning model 300 in performing tasks associated with the domain 254, it also improves the performance of the machine learning model 300 in performing tasks associated with the domain 252.

One advantage of such a machine learning model that uses mixtures of experts is that it is highly scalable. Even after the machine learning model 300 has been configured and trained, the machine learning model 300 can be scaled to include additional domains. For example, to include the domain 256, the transaction processing module 132 may modify the machine learning model 300 by including an additional input layer configured to receive input data corresponding to features that are unique to the domain 256, an additional domain expert connected to the new input layer and configured to handle data specifically for the domain 256, and an additional aggregator that receive intermediate output values from the newly added domain expert and the common expert 314, and an additional output layer for providing an output value for the domain 256. Without training or retraining the machine learning model 300, the machine learning model 300 may immediately begin performing tasks associated with the new domain 256 with improved prediction accuracy, as the knowledge acquired by the common expert 314 can be applied to the tasks associated with the domain 256.

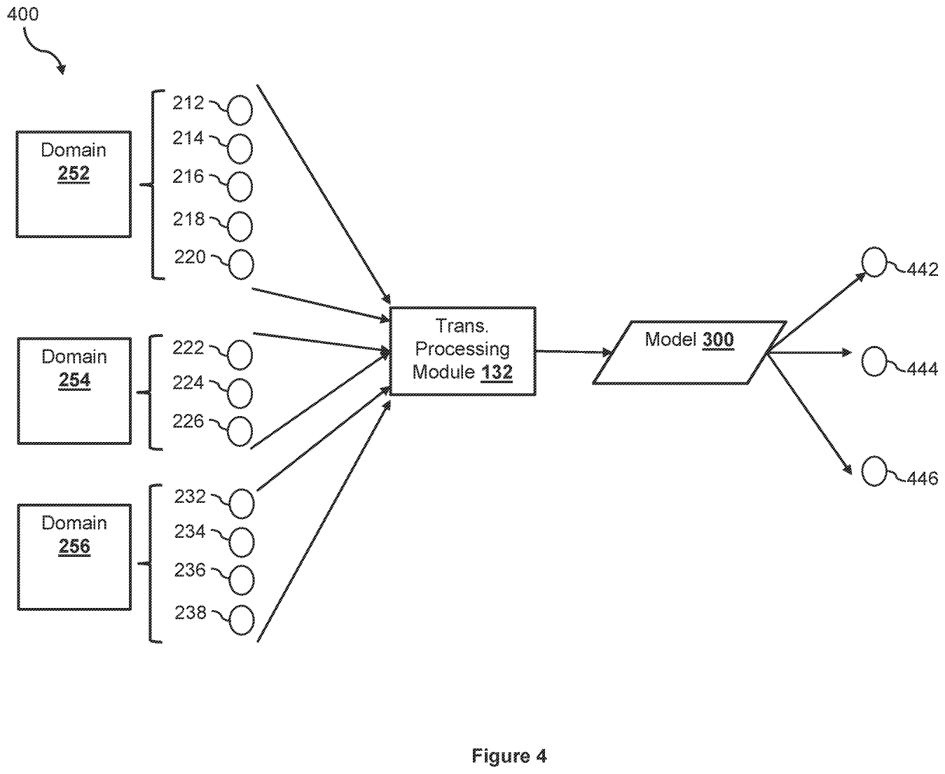

FIG. 4 illustrates a schematic 400 of the transaction processing module 132 that uses the machine learning model 300 for processing transactions according to various embodiments of the disclosure. As shown, the transaction processing module 132 is configured to use a single model (e.g., the machine learning model 300) to process transactions across different domains, such as the domains 252, 254, and 256. The machine learning model 300 is configured to process an incoming transaction differently and produce a different output based on the domain associated with the transaction. For example, when the transaction is associated with the domain 252, the transaction processing module 132 may obtain input values corresponding to the features 212, 214, 216, 218, and 220 for the machine learning model 300, and provide an output 442 (e.g., an indication of whether the transaction is fraudulent or not). When the transaction is associated with the domain 254, the transaction processing module 132 may obtain input values corresponding to the features 222, 224, and 226 for the machine learning model 300, and provide an output 444 (e.g., an indication of whether the transaction is fraudulent or not). When the transaction is associated with the domain 256, the transaction processing module 132 may obtain input values corresponding to the features 232, 234, 236, and 238 for the machine learning model 300, and provide an output 442 (e.g., an indication of whether the transaction is fraudulent or not).

As discussed herein, since the machine learning model 300 is highly scalable and flexible, the transaction processing module 132 can switch from processing transactions associated with one domain to processing transactions associated with another domain efficiently. Having to store and manage only a single machine learning model 300 (instead of storing and managing multiple models for the different domains) also improves the computer storage and computer resources efficiency for the transaction processing module 132. Furthermore, since knowledge acquired by the machine learning model 300 (and specifically, the common expert 314) can be applied immediately for the machine learning model 300 to process tasks for any of the domains, the transfer of knowledge can occur in a seamless manner, without requiring additional steps (e.g., reconfiguring and/or retraining other machine learning models, etc.).

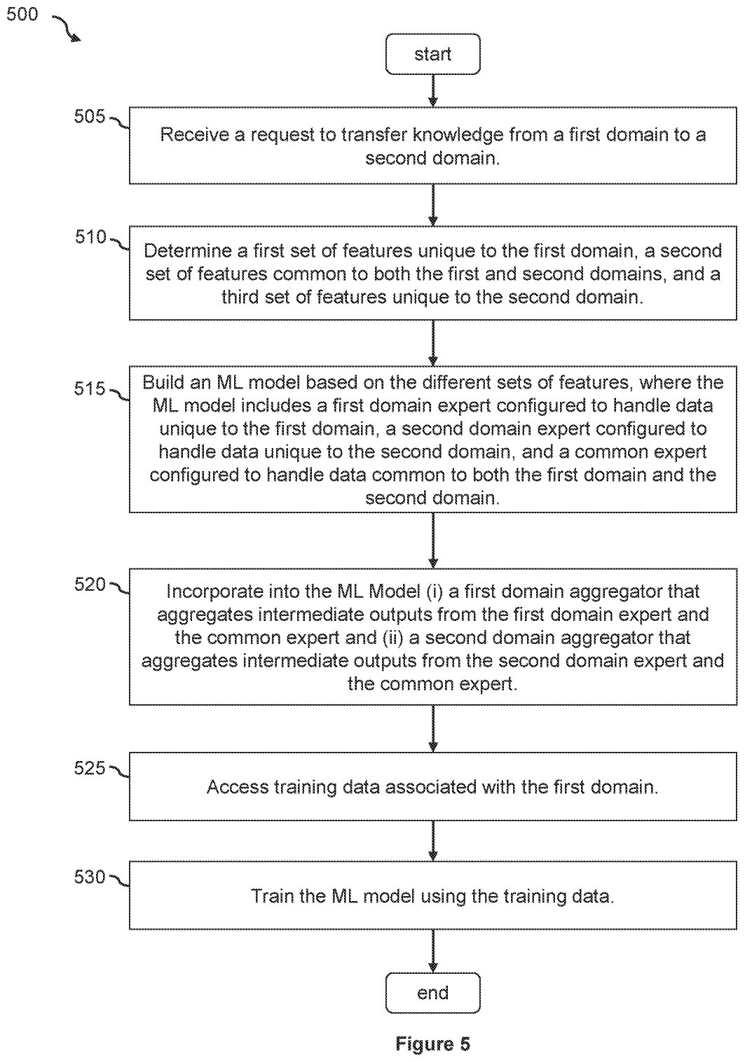

FIG. 5 illustrates a process 500 for configuring and training a machine learning model that uses mixtures of experts according to various embodiments of the disclosure. In some embodiments, at least a portion of the process 500 may be performed by the transaction processing module 132. The process 500 begins by receiving (at step 505) a request to transfer knowledge from a first domain to a second domain. For example, the service provider associated with the service provider server 130 may have been providing services related to processing ACH transactions (first domain). When the service provider expands its services to include processing other types of transactions (a second domain, such as processing debit card transactions, cryptocurrency transactions, etc.), the service provider may request the transaction processing module 132 to transfer knowledge from the first domain to the second domain.

The process 500 then determines (at step 510) a first set of features unique to the first domain, a second set of features common to both the first and second domains, and a third set of features unique to the second domain. For example, the transaction processing module 132 may determine features that are related to the first domain (e.g., features that have been used by the transaction processing module 132 to perform tasks associated with the first domain). The transaction processing module 132 may also determine features that are related to the second domain (e.g., features that the transaction processing module 132 determines that may be useful for performing tasks associated with the second domain). The transaction processing module 132 may then divide the features related to the first domain and the second domain into three groups: a first group that includes features unique to the first domain, a second group that includes features unique to the second domain, and a third group that includes features that are common to both the first domain and the second domain.

The process 500 then builds (at step 515) a machine learning model based on the different sets of features, where the machine learning model includes a first domain expert configured to handle data unique to the first domain, a second domain expert configured to handle data unique to the second domain, and a common expert configured to handle data common to both the first domain and the second domain, and incorporates (at step 520) into the machine learning model (i) a first domain aggregator that aggregates intermediate outputs from the first domain expert and the common expert and (ii) a second domain aggregator that aggregates intermediate outputs from the second domain expert and the common expert.

In some embodiments, each of the first domain expert, the second domain expert, and common expert may be connected to a corresponding input layer and may include one or more hidden layers. For example, the first domain expert may be connected to a first domain input layer configured to receive input values corresponding to the first group of features. The first domain expert may also be configured to analyze and manipulate the input values to generate intermediate outputs for the first aggregator. Similarly, the second domain expert may be connected to a second domain input layer configured to receive input values corresponding to the second group of features. The second domain expert may also be configured to analyze and manipulate the input values to generate intermediate outputs for the second aggregator. The common expert may be connected to a common input layer configured to receive input values corresponding to the third group of features. The common expert may also be configured to analyze and manipulate the input values to generate intermediate outputs for both of the first aggregator and the second aggregator.

In some embodiments, each of the first aggregator and the second aggregator may also include one or more hidden layers for further processing and/or manipulating data. For example, the first aggregator may receive the intermediate output values from the first domain expert and the common expert, analyze and manipulate the intermediate output values collectively, and provide one or more outputs to a first domain output layer. Similarly, the second aggregator may receive the intermediate output values from the second domain expert and the common expert, analyze and manipulate the intermediate output values collectively, and provide one or more outputs to a second domain output layer.

The process 500 accesses (at step 525) training data associated with the first domain and trains (at step 530) the machine learning model using the training data. For example, the transaction processing module 132 may generate training data using historic transaction data associated with ACH transactions conducted through the service provider server 130 in the past. The transaction processing module 132 may then train the machine learning model using the training data. The use of the different experts in the machine learning model enables the machine learning model to use knowledge learned by the machine learning model from the training data associated with the first domain when performing tasks associated with the second domain.

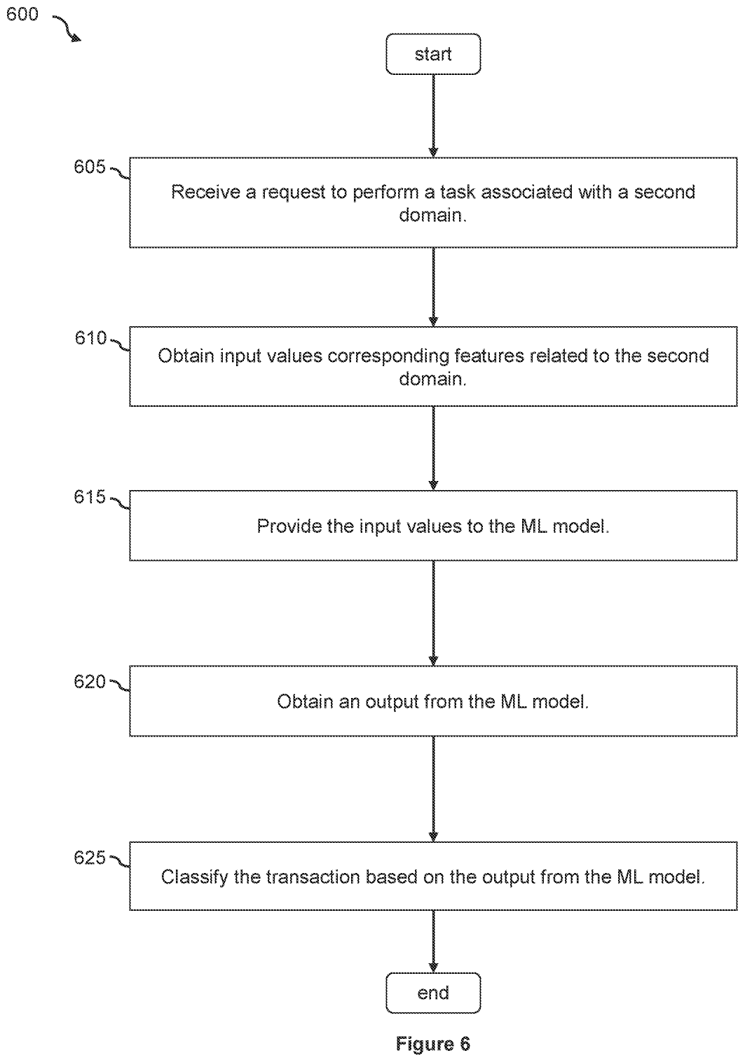

FIG. 6 illustrates a process 600 for utilizing a machine learning model that uses mixtures of experts to perform tasks associated with different domains according to various embodiments of the disclosure. In some embodiments, at least a portion of the process 600 may be performed by the transaction processing module 132. The process 600 begins by receiving (at step 605) a request to perform a task associated with a second domain. For example, the transaction processing module 132 may be requested to process a debit card transaction for a user. In order to process the debit card transaction, the transaction processing module 132 may use the machine learning model, that has been trained using training data associated with the first domain, to determine a risk associated with the debit card transaction.

The process 600 then obtains (at step 610) input values corresponding features related to the second domain, and provides (at step 615) the input values to the machine learning model. For example, the transaction processing module 132 may extract attribute values associated with the debit card transaction from the request. The attribute values may correspond to features such as an amount associated with the debit card transaction, a bank associated with the debit card transaction, device attributes associated with a device used by the user to submit the request, etc. These features were determined to be related to the second domain as they can assist the machine learning model to derive pattern in assessing risks associated with different debit card transactions. As discussed herein, some of the features may be common with the features related to the first domain, and others may be unique to the second domain. The transaction processing module 132 may provide the attribute values of the transaction to the machine learning model.

The attribute values may be provided to the second domain input layer and the common input layer, and then passed to the second domain expert and the common expert. Each of the second domain expert and the common expert may analyze and manipulate the respective attribute values based on parameters associated with the nodes in the respective expert, and provide one or more intermediate output values to the second aggregator. The second aggregator may aggregates the intermediate output values from the second domain expert and the common expert, perform further analysis and manipulations to the intermediate output values collectively, and provide one or more output values to the second domain output layer.

The process 600 then obtains (at step 620) an output from the machine learning model and classifies (at step 625) the transaction based on the output from the machine learning model. For example, the transaction processing module 132 may obtains the one or more output values from the second domain output layer. Based on the output values (e.g., by comparing the output values to one or more threshold values), the transaction processing module 132 may classify the debit card transaction as fraudulent or not.

It is noted that while various types of payment transactions have been used throughout the discussion as examples for different domains for which the machine learning model can perform tasks, the machine learning techniques disclosed herein are applicable to other types of domains as well and are not limited to payment transaction domains.

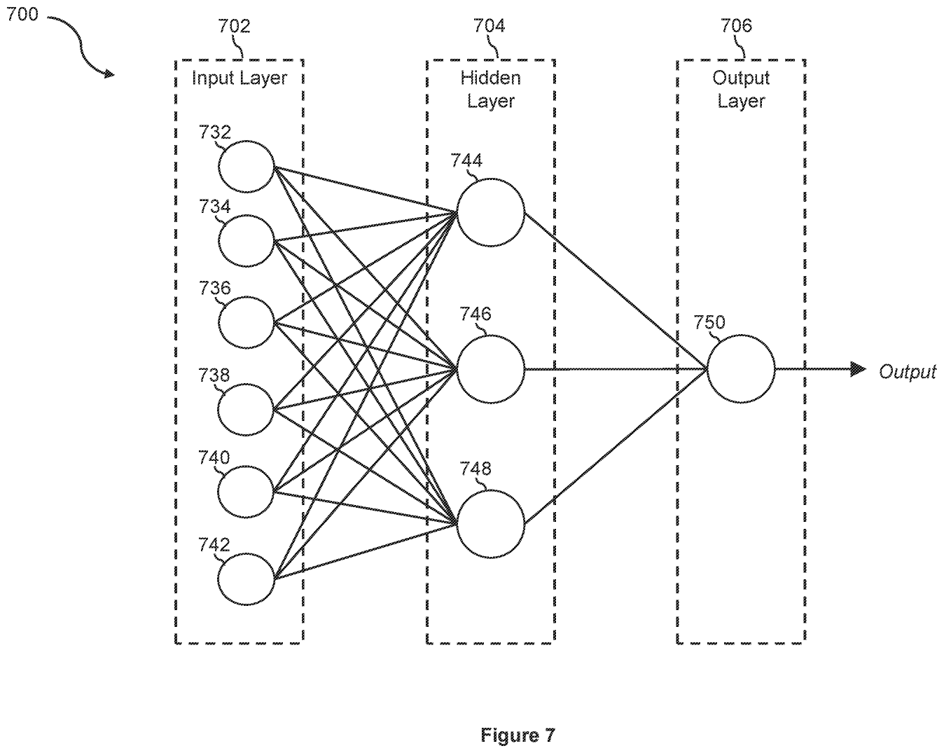

FIG. 7 illustrates an example artificial neural network 700 that may be used to implement the machine learning model 300 (or at least a portion of the machine learning model 300). As shown, the artificial neural network 700 includes three layers—an input layer 702, a hidden layer 704, and an output layer 706. Each of the layers 702, 704, and 706 may include one or more nodes. For example, the input layer 702 includes nodes 732, 734, 736, 738, 740, and 742, the hidden layer 704 includes nodes 744, 746, and 748, and the output layer 706 includes a node 750. In this example, each node in a layer is connected to every node in an adjacent layer. For example, the node 732 in the input layer 702 is connected to all of the nodes 744, 746, and 748 in the hidden layer 704. Similarly, the node 744 in the hidden layer is connected to all of the nodes 732, 734, 736, 738, 740, and 742 in the input layer 702 and the node 750 in the output layer 706. Although only one hidden layer is shown for the artificial neural network 700, it has been contemplated that the artificial neural network 700 used to implement any one of the computer-based models may include as many hidden layers as necessary.

In this example, the artificial neural network 700 receives a set of inputs and produces an output. Each node in the input layer 702 may correspond to a distinct input. For example, each node in the input layer 702 may correspond to an input feature (e.g., features 212, 214, 216, 218, and 220). It has been contemplated that each of the input layers 302, 304, and 306 may be implemented as the input layer 702 of the artificial neural network 700. When the input layer 702 is used to implement the input layer 302, each of the nodes 732, 734, 736, 738, 740, and 742 may corresponds to a feature that is unique to the domain 252. When the input layer 702 is used to implement the input layer 306, each of the nodes 732, 734, 736, 738, 740, and 742 may corresponds to a feature that is unique to the domain 254. When the input layer 702 is used to implement the input layer 304, each of the nodes 732, 734, 736, 738, 740, and 742 may corresponds to a feature that is common to both of the domain 252 and the domain 254.

In some embodiments, each of the nodes 744, 746, and 748 in the hidden layer 704 generates a representation, which may include a mathematical computation (or algorithm) that produces a value based on the input values received from the nodes 732, 734, 736, 738, 740, and 742. The mathematical computation may include assigning different weights (e.g., node weights, etc.) to each of the data values received from the nodes 732, 734, 736, 738, 740, and 742. The nodes 744, 746, and 748 may include different algorithms and/or different weights assigned to the data variables from the nodes 732, 734, 736, 738, 740, and 742 such that each of the nodes 744, 746, and 748 may produce a different value based on the same input values received from the nodes 732, 734, 736, 738, 740, and 742. In some embodiments, the weights that are initially assigned to the input values for each of the nodes 744, 746, and 748 may be randomly generated (e.g., using a computer randomizer). The values generated by the nodes 744, 746, and 748 may be used by the node 750 in the output layer 706 to produce an output value for the artificial neural network 700. In some embodiments, the hidden layer 704 as described herein can be used to implement any one of the domain expert 312, the common expert 314, the domain expert 316, the aggregator 322, and the aggregator 324.

The artificial neural network 700 may be trained by using training data and one or more loss functions. By providing training data to the artificial neural network 700, the nodes 744, 746, and 748 in the hidden layer 704 may be trained (adjusted) based on the one or more loss functions such that an optimal output is produced in the output layer 706 to minimize the loss in the loss functions. By continuously providing different sets of training data, and penalizing the artificial neural network 700 when the output of the artificial neural network 700 is incorrect (as defined by the loss functions, etc.), the artificial neural network 700 (and specifically, the representations of the nodes in the hidden layer 704) may be trained (adjusted) to improve its performance in the respective tasks. Adjusting the artificial neural network 700 may include adjusting the weights associated with each node in the hidden layer 704.

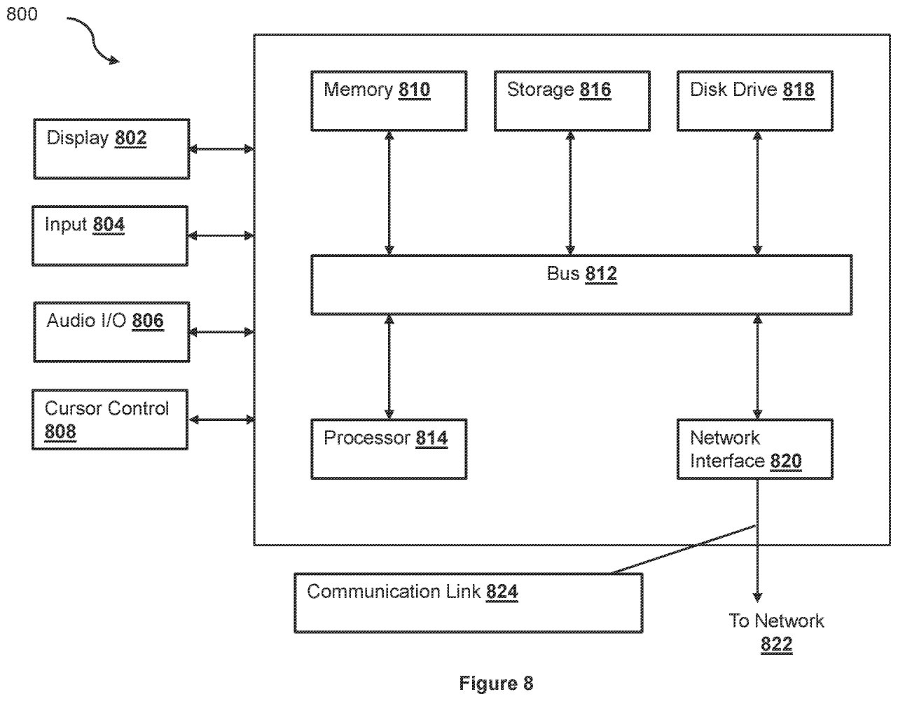

FIG. 8 is a block diagram of a computer system 800 suitable for implementing one or more embodiments of the present disclosure, including the service provider server 130, the merchant server 120, the user device 110, and the devices 180 and 190. In various implementations, each of the user device 110, the device 180, and the device 190 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, 180, and 190 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the machine learning based knowledge transfer functionalities described herein, for example, according to the processes 500 and 600.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
receiving a request for processing a transaction corresponding to a first domain;
accessing a neural network for processing the request, wherein the neural network comprises a first domain expert corresponding to a first set of input features unique to the first domain, a common expert corresponding to a second set of input features shared by the first domain and a second domain different from the first domain, and a second domain expert corresponding to third set of input features unique to the second domain;
obtaining a set of input values associated with the transaction, wherein the set of input values comprises a first set of values corresponding to the first set of input features and a second set of values corresponding to the second set of input features;
providing the first set of values and the second set of values to the first domain expert and the common expert of the neural network, respectively; and
processing the transaction based on an output obtained from the neural network.

2. The system of claim 1, wherein the neural network further comprises a first input layer configured to receive first input values corresponding to the first set of input features, and wherein the first domain expert is connected to the first input layer and comprises a first set of hidden layers configured to manipulate the first input values and provide a first set of intermediate output values.

3. The system of claim 2, wherein the neural network further comprises a second input layer configured to receive second input values corresponding to the second set of input features, and wherein the common expert is connected to the first input layer and comprises a second set of hidden layers configured to manipulate the first input values and provide a second set of intermediate output values.

4. The system of claim 1, wherein the first domain expert is not connected to the common expert in the neural network, and wherein the neural network further comprises a first domain aggregator configured to aggregate a first set of intermediate output values from the first domain expert and a second set of intermediate output values from the common expert.

5. The system of claim 4, wherein the first domain aggregator is further configured to generate the output based on the first set of intermediate output values and the second set of intermediate output values.

6. The system of claim 4, wherein the first domain aggregator comprises one or more hidden layers.

7. The system of claim 4, wherein the neural network further comprises a first gate configured to control a first contribution factor of the first set of intermediate output values and a second contribution factor of the second set of intermediate output values for the first aggregator.

8. A method, comprising:
receiving a request for processing a transaction corresponding to a first domain;
obtaining a set of input values associated with the transaction, wherein the set of input values corresponds to input features related to the first domain;
providing the set of input values to a machine learning model configured to perform risk prediction associated with the first domain, wherein the machine learning model comprises a first domain expert corresponding to a first set of input features unique to the first domain, a common expert corresponding to a second set of input features shared by the first domain and a second domain different from the first domain, and a second domain expert corresponding to third set of input features unique to the second domain;
determining a risk associated with the transaction based on one or more outputs from the machine learning model; and
processing the transaction based on the risk.

9. The method of claim 8, further comprising:
obtaining a first set of training data corresponding to the second domain; and
prior to providing the set of input values to the machine learning model, training the machine learning model using the first set of training data.

10. The method of claim 9, wherein the training the machine learning model using the first set of training data comprises modifying the common expert, but not the first domain expert, of the machine learning model.

11. The method of claim 8, further comprising:
obtaining a first set of training data corresponding to the first domain;
obtaining a second set of training data corresponding to the second domain;
generating a merged set of training data based on merging the first set of training data with the second set of training data; and
training the neural network using the merged set of training data.

12. The method of claim 8, wherein the first domain expert is configured to manipulate a first subset of the set of input values corresponding to the first set of input features and generate a first set of intermediate output values, and wherein the common expert is configured to manipulate a second subset of the set of input values corresponding to the second set of input features and generate a second set of intermediate output values.

13. The method of claim 12, wherein the first domain expert is further configured to manipulate the first subset of the set of input values independent of the common expert.

14. The method of claim 12, wherein the machine learning model further comprises a first aggregator configured to aggregate the first set of intermediate output values from the first domain expert and the second set of intermediate output values from the common expert and to generate the one or more outputs for the machine learning model.

15. A non-transitory machine-readable medium having stored thereon machine-readable instructions executable to cause a machine to perform operations comprising:
receiving a request for processing a transaction corresponding to a first domain;
accessing a machine learning model based on the request, wherein the machine learning model was trained with a first domain expert corresponding to a first set of input features unique to the first domain, a common expert corresponding to a second set of input features shared by the first domain and a second domain different from the first domain, and a second domain expert corresponding to third set of input features unique to the second domain;
providing a set of input values associated with the transaction to the machine learning model, wherein the machine learning model is configured to use the first domain expert to process a first subset of the set of input values corresponding to the first set of input features and to use the common expert to process a second subset of the set of input values corresponding to the second set of input features; and
processing the transaction based on an output obtained from the machine learning model.

16. The non-transitory machine-readable medium of claim 15, wherein the operations further comprise:
obtaining a first set of training data corresponding to the second domain; and
prior to providing the set of input values to the machine learning model, training the machine learning model using the first set of training data.

17. The non-transitory machine-readable medium of claim 16, wherein the training the machine learning model using the first set of training data comprises modifying the common expert, but not the first domain expert, of the machine learning model.

18. The non-transitory machine-readable medium of claim 15, wherein the first domain expert is not connected to the common expert in the machine learning model, and wherein the machine learning model further comprises a first domain aggregator configured to aggregates a first set of intermediate output values generated by the first domain expert and a second set of intermediate output values generated by the common expert.

19. The non-transitory machine-readable medium of claim 18, wherein the first domain aggregator is configured to generate the output based on the first set of intermediate output values and the second set of intermediate output values.

20. The non-transitory machine-readable medium of claim 18, wherein the first domain aggregator comprises one or more hidden layers.
